(19) United States
(12) Patent Application Publication
(10) Pub. No.: US 2005/0087654 A1
(43) Pub. Date: Apr. 28, 2005

(54) Instrument panel system

(75) Inventors: Thomas J. Fowler, Clarkston, MI (US); Karl R. Kennedy, Fraser, MI (US); Gregory F. Breakey, Clair Shores, MI (US); David A. Hein, Sterling Heights, MI (US); Chris D. Spielman, Rodford, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/692,955

(22) Filed: Oct. 24, 2003

(51) Int. Cl. G12B 9/00

(52) U.S. Cl. 248/27.1

(57) ABSTRACT

An instrument panel system which can accommodate different sized displays within a common instrument panel structure. The instrument panel system can accommodate different sized devices within the common instrument panel architecture without showing an empty intermediate area between the device and the instrument panel when the device received within the opening is smaller than an area of the opening.

### BACKGROUND OF THE INVENTION

1. Field of the Invention

The present invention relates to an instrument panel system which permits different sized devices to be used within a common instrument panel architecture.

2. Background Art

In the automotive industry, an common instrument panel architecture is commonly used for a particular vehicle model. Typically, the common architecture includes a common set of openings for the different devices which may be purchased for the vehicle.

The opening are generally sized relative to the largest device option which can be used in the opening. In this manner, an opening assigned to a LCD display would include an area sufficient for receiving the largest available LCD display. In general, a LCD display for a high end version of the vehicle may include a relatively large size LCD display in comparison to a low end version which includes a relatively small size LCD display.

Because of the common instrument panel architecture, the opening for the LCD display includes an opening area to match the largest LCD display. As such, an intermediate area of the opening between the LCD display and the instrument panel can be seen when an LCD display having an area smaller than the area of the opening is selected.

The intermediate area appears as an aesthetically undesirable empty portion in the instrument panel. As such, there exists a need to provide an instrument panel system which can accommodate different sized devices within a common instrument panel architecture without showing the empty intermediate area when the device received within the opening is smaller than the area of the opening.

### SUMMARY OF THE INVENTION

The present invention provides an instrument panel system which meets the need identified above. In particular, the instrument panel system can accommodate different sized devices within a common instrument panel architecture without showing an empty intermediate area between the device and the instrument panel when the device received within the opening is smaller than an area of the opening.

One aspect of the present invention relates to a secondary panel. When the device received within the opening is smaller than an area of the opening, the secondary panel can be attached to the instrument panel to form an intermediate surface for covering the empty intermediate area between the device and the instrument panel. Preferably, the secondary panel can be removably or permanently attached to the instrument panel.

The secondary panel can comprises a one-way transmissible material which passes light in one direction through the secondary panel. In this manner, a display, such as an LCD display, having an area smaller than the area of the opening can be used and covered by the secondary panel such that the empty intermediate area between the display and the instrument panel is concealed when the display is inactive, yet the one-way transmissible material still permits the covered LCD display to be viewed from the passenger compartment when active.

The secondary panel can also comprise an opaque material specifically shaped to fit around the display for covering the empty intermediate area. In this manner, if the smaller size display is used, a secondary panel conforming to the size and shape of the empty intermediate area can be selected. Preferably, the opaque secondary panel is removably attachable to the instrument panel such that an occupant can change the appearance of the instrument panel system by replacing the secondary panel with another secondary panel. The different opaque secondary panels can include designs and other ornamental appearances to permit different panels to be attached for different aesthetic appearances.

The secondary panel can also comprise an opaque portion and a transparent portion. The opaque portions is shaped to cover the empty intermediate area and the transparent portions is shaped to cover a display. In this manner, the display is visible to the passenger compartment though the transparent portion and the empty intermediate area is covered by the opaque portion.

### BRIEF DESCRIPTION OF THE DRAWINGS

FIG. 1 illustrates an instrument panel system which permits different sized devices to be used within a common instrument panel architecture;

FIG. 2 illustrates an empty intermediate area created within an opening of the instrument panel system of the present invention;

FIG. 3 illustrates a secondary panel having an aperture for use with the instrument panel system of the present invention;

FIG. 4 illustrates a secondary panel having multiple apertures for use with the instrument panel system of the present invention;

FIG. 5 illustrates an L-shaped secondary panel for use with an instrument panel system of the present invention;

FIG. 6 illustrates a picture holder secondary panel for use with the instrument panel system of the present invention;

FIG. 7 illustrates a bi-material secondary panel for use with the instrument panel system of the present invention; and

FIG. 8 illustrates a one-way light transmissible material secondary panel for use with the instrument panel system of the present invention.

### DETAILED DESCRIPTION OF THE PREFERRED EMBODIMENT(S)

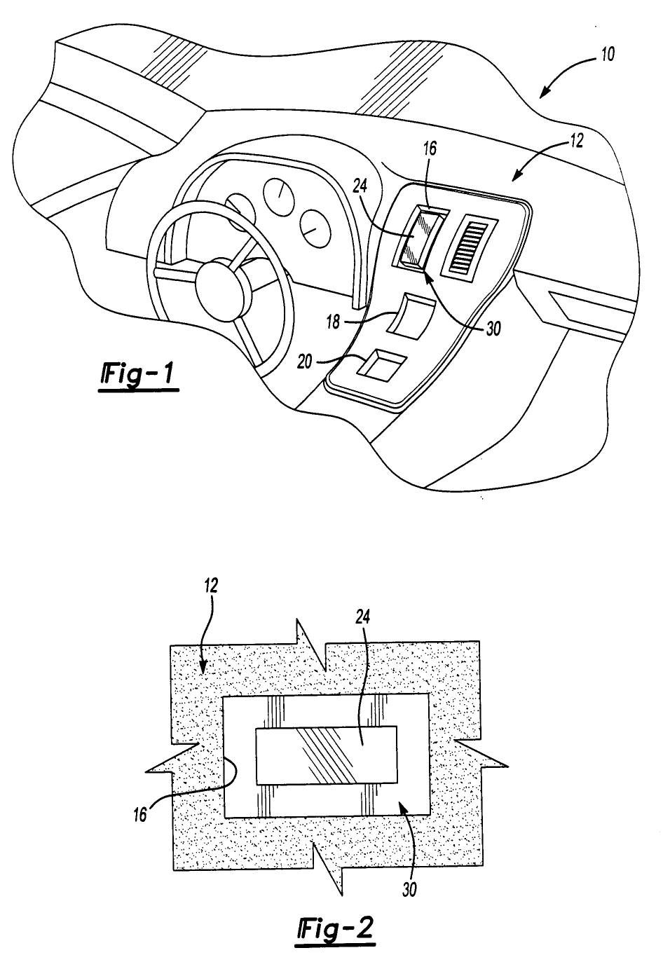

FIG. 1 illustrates an instrument panel system 10 of the present invention. The instrument panel system 10 comprises an instrument panel 12, a number of openings 16, 18, 20, and a device 24 in the opening 16. As shown, some of the openings 18, 20, are not shown to include a device, but typically a device is included in each opening.

The instrument panel system 10 relates to an automobile, however, the present invention is not limited to automobiles. Rather, the present invention applies to airplanes, boats, and other vehicles, as one having ordinary skill in the art will appreciate.

For exemplary purposes, the device 24 referred to below is a display device, such as an LCD display. The device 24, however, is not limited to displays or LCD displays. Rather, the instrument panel 12 can include a number of openings for different devices, including a cathode ray tube display, light emitting diodes, control panels to control vehicle systems, switches, buttons, a radio controller, an air conditioning controller, a CD player, a tape player, and other display units for conveying information to or receiving information from a passenger compartment.

The instrument panel 12 preferably includes a common architecture which includes a predefined arrangement for the openings 16, 18, 20. This means the common instrument panel 10 can be used with different versions of a single vehicle model. The opening area for each opening is sufficiently sized relative to the largest device which can be purchased for use in the opening.

For example, the vehicle model may include different options for a LCD display 24. The LCD display 24 for a high end version of the vehicle may include a relatively large size LCD display in comparison to a low end version which includes a relatively smaller size LCD display.

Because of the common instrument panel architecture, the opening area 16 for the LCD display 24 is sized to match the large size LCD display. The openings 16, 18, 20 are configured to receive one of a plurality of devices, such as the LCD display device 24. As shown in FIG. 1, if the small LCD display is used, an empty intermediate area 30 of the display becomes visible.

FIG. 2 illustrates a partial view of the instrument panel 12 as viewed from the passenger compartment with more detail on the empty intermediate area 30. The size of the empty intermediate area 30 is generally proportional to a difference in area between the device 24 and the instrument panel 12 when the device 24 received within the opening 16 is smaller than an area of the opening 16.

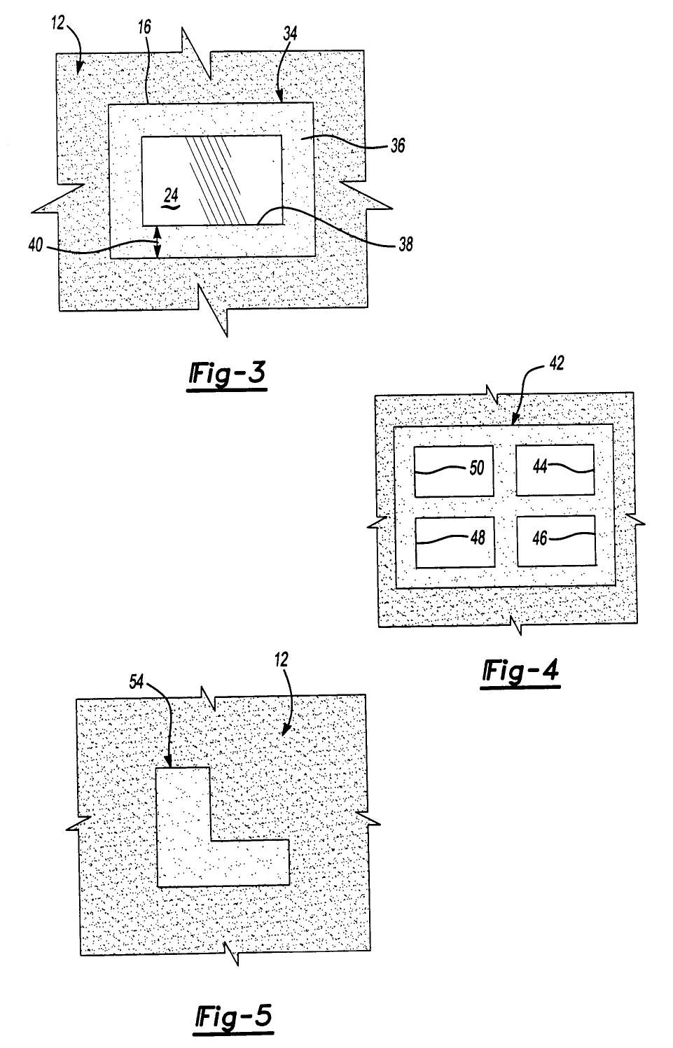

FIG. 3 illustrates a secondary panel 34 which can be used with the instrument panel system 10. The secondary panel 34 forms an intermediate surface 36 to cover the empty intermediate area 30 in the opening to hide the aesthetically undesirable empty intermediate area 30.

The secondary panel 34 includes an aperture 38 to fit around the display 24. Extending relative to the aperture is an extended portion 40 of the intermediate surface 36. The extended portion 40 is sized cover the empty intermediate area 30 in the opening. In this manner, the secondary panel 34 is said to ring the display 24.

The size of the extended portion 40 is typically proportion to the difference in size between the display and the opening. A number of differently sized secondary panels can be made to facilitate the manufacturing of the instrument panel system 10. From the supply of secondary panels, the properly sized secondary panel is selected and attached to the instrument panel 12.

The secondary panel 34 can be removably or permanently attachable to the instrument panel 12. The removably attachable secondary panel 34 permits the secondary panel 34 to be removed and replaced after manufacturing with relative ease.

Optionally, the secondary panel 34 can include a material which matches an outer skin material of the instrument panel. The matched material provides a continuous appearance to the instrument panel such that the portion of the opening covered by the secondary panel appears to substantially match with the rest of the instrument panel 12. In this manner, the secondary panel 34 is configured to meet the instrument panel 12 such that the instrument panel appears substantially integral to the occupant.

The material of the secondary panel 34 can also include different aesthetic appearances such that an occupant can change the appearance of the instrument panel system 10 by replacing the secondary panel 34 with another secondary panel 34. The different secondary panels can include designs and other ornamental appearances to permit different panels to be attached for different aesthetic appearances.

FIG. 4 illustrates a secondary panel 42 having multiple apertures 44, 46, 48, 50. The multiple apertures 44, 46, 48, 50 are provided to cover multiple empty intermediate areas in the same opening. Typically, the multiple empty intermediate areas are caused by multiple displays or devices in the some opening or sizing of the secondary panel 42 to cover a substantial portion of the instrument panel 12 such that multiple openings are covered by a single secondary panel 42.

FIG. 5 illustrates an L-shaped secondary panel 54. The L-shaped secondary panel is used to cover an irregular shaped empty intermediate area in the opening. The L-shaped secondary panel 54 can be used when the small size display cannot be positioned within the center of the opening or other deficiency prevents a more uniformly shaped secondary panel.

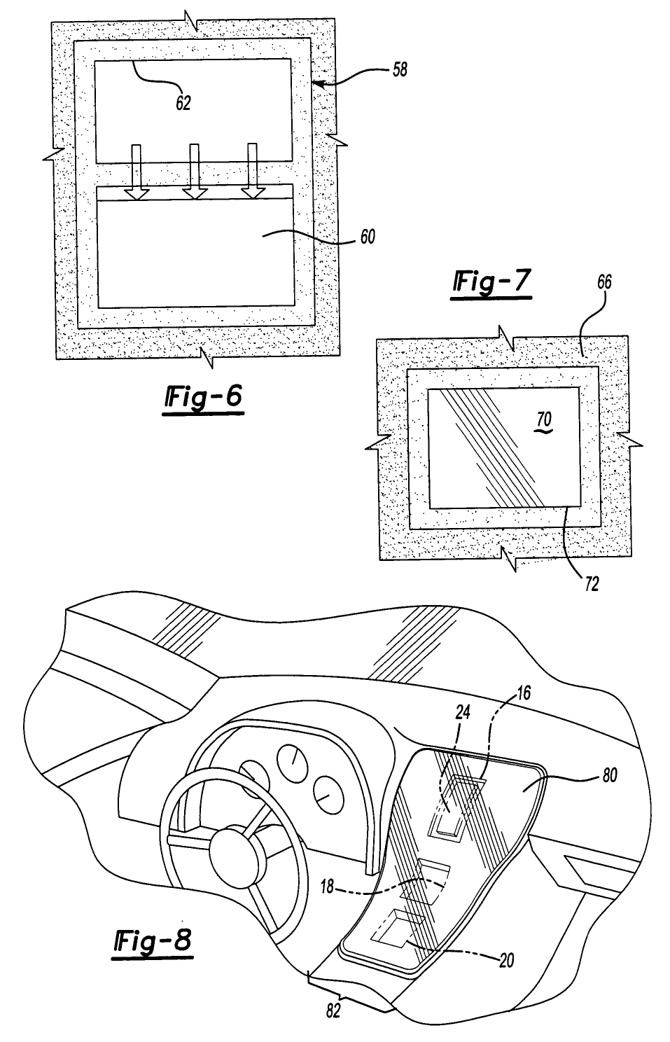

FIG. 6 illustrates a picture holder secondary panel 58. The picture holder secondary panel 58 includes a picture opening 60 to receive a picture. The picture is inserted into the opening 60 as shown with the arrow. Preferably, the picture holder secondary panel 58 includes an aperture 62 to fit around a display.

FIG. 7 illustrates a bi-material secondary panel 66. The bi-material secondary panel 66 includes a transparent portion 70 and an opaque portion 72. The bi-material secondary panel 66 permits viewing of the display through the transparent portion 70 and concealing of the empty intermediate area with the opaque portion 72.

FIG. 8 illustrates a secondary panel 80 having one-way light transmissible material used to cover each opening 16, 18, 20. The one-way material secondary panel 80 is preferably sized to cover an entire center console portion 82 of the instrument panel, but it can be larger or small. Specifically, the one-way material secondary panel 80 can be sized to fit one or more of the openings 16, 18, 20.

The one-way material secondary panel 80 advantageously covers the entire opening to cover the empty intermediate area 30 regardless of the display size. In other words, the empty intermediate area is covered regardless of whether the large or small size display is used. Typically, the secondary panel 80 extends slightly beyond the opening to insure the any empty intermediate area that may even appear with use of the largest size display due to tolerance gaps is covered.

The one-way material is such that sufficiently viewable light only pass from behind the secondary panel to the passenger area and not from the passenger area to behind the secondary panel, i.e. in only one direction. In this manner, the covered display is viewable when active but concealed when inactive.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. In a vehicle having a passenger compartment, an instrument panel system comprising:
an instrument panel having an opening configured to receive one of a plurality of devices, the device received to be accessible by an occupant in the passenger compartment through the opening, wherein the opening has an area and each of the plurality of devices has an area substantially equal to or less than the area of the opening; and
a removably attachable secondary panel for covering a portion of the opening when the device received has an area less than the area of the opening, the secondary panel forming an intermediate surface visible to the occupant between the instrument panel and at least a portion of the device, wherein the intermediate surface substantially surrounds the device.

2. (canceled)

3. The instrument panel system of claim 1 wherein the secondary panel includes an aperture through which the received device is accessible to the occupant.

4. The instrument panel system of claim 1 wherein the received device is a display for use in conveying information to the occupant.

5. The instrument panel system of claim 1 wherein the received device is a control panel for use by the occupant to control at least one vehicle system.

6. The instrument panel system of claim 1 wherein the surface of the secondary panel visible to the occupant substantially matches the surface of the instrument panel visible to the occupant.

7. The instrument panel system of claim 6 wherein the instrument panel and secondary panel are configured to meet so that the instrument panel and secondary panels appear substantially integral to the occupant.

8. The instrument panel system of claim 1 wherein the instrument panel comprises a plurality of openings, each opening configured to receive one of a plurality of devices, and wherein the secondary panel includes a plurality of apertures through which the received devices are accessible to the occupant.

9. The instrument panel system of claim 1 wherein the secondary panel is removably attachable by the occupant, and the system further comprises at least one additional secondary panel having a different appearance than the secondary panel, such that the occupant can change the appearance of the instrument panel system by replacing the secondary panel with the at least one additional secondary panel.

10-21. (canceled)
